(19) United States
(12) Patent Application Publication
(10) Pub. No.: US 2022/0255161 A1
(43) Pub. Date: Aug. 11, 2022

(54) ELECTRIC BATTERIES COOLING SYSTEM

(71) Applicant: CARRAR LTD, Shar Hanegev, Hof Ashkelon (IL)

(72) Inventor: Nahshon EADELSON, Shaar Hanegev, Hof Ashkelon (IL)

(21) Appl. No.: 17/628,656

(22) PCT Filed: Jul. 22, 2020
(86) PCT No.: PCT/IL2020/050809

§ 371 Date: Jan. 20, 2022

Related U.S. Application Data
(60) Provisional application No. 62/876,953, filed on Jul. 22, 2019.

(51) Int. Cl. H01M 10/6555; H01M 10/613; H01M 10/625

(52) U.S. Cl. CPC H01M 10/6555; H01M 2220/20; H01M 10/625; H01M 10/613

(57) ABSTRACT

The present invention provides methods and systems for cooling electric batteries.

### FIELD OF THE INVENTION

The present invention relates in general to electric batteries, particularly to methods and systems for cooling electric batteries, such as ones used in electric vehicles.

### BACKGROUND

Electric devices and especially electric vehicles use large batteries, and often a pack of several batteries, to store energy. Usually, each battery is comprised of several cells. The energy flowing into the batteries during charging (e.g. from regenerative braking or when plugged to the main power grid) and out of them when they are discharged (e.g. to power the vehicle and its accessories), is measured by electrical current and voltage. The flow of current causes/creates heating in the battery cells and their interconnection systems, such that higher current flow causes a greater heating effect.

However, heating of the batteries may damage them, reduce their capacity and recharging capabilities, and may also lead to overheating and the breaking of fire. Accordingly, cooling the batteries is essential in all electric devices, especially to those that are susceptible to exposure to excess heat, such as electric vehicles.

For instance, Lithium-ion battery cells performance is greatly impacted by their temperature. Such batteries suffer from the Goldilocks effect, which means that they do not perform well when too cold or too hot (e.g. above 45° C.), which can lead to permanent and extreme damage to the cells or to their accelerated degradation.

Originally, large battery packs did not need any special cooling system since their physical size was sufficient to maintain them at a low temperature. In addition, the relative flow of current was low compared to the overall capacity of the pack, which further prevented overheating of the batteries pack. However, with the increase of overall electrical usage, e.g. due to higher performance electric vehicles with a requirement for consistent performance and adequate durability, and the need for increased charging rates, e.g. to enable faster charging and “fueling” for increasing driving distance, special thermal management methods for the battery pack are required to maintain the batteries' temperature at a desired level and avoid overheating.

Currently, two common battery thermal management methods are used: (1) air-cooling by convection of air either passively or actively (i.e. forced); and (2) liquid-based cooling, which is divided into two: (a) oil-cooling by flooding the battery/cells with a dielectric oil (or other oil-based coolant) that is pumped out to a heat exchanger system; and (b) water-cooling by circulating water-based coolant through cooling passages within the battery structure, such the passing water absorb the heat (e.g. by evaporation) and discharge it away therefrom. However, air cooling is not suitable for today's new high-performance applications, e.g., due to power density required and the inability to cope with a wide range of ambient temperatures.

According to Hunt et al., J. Electrochemical. Soc., 2016, the cooling method is critical to preserve long lifetime performance of the battery cells. Hunt et al. determined that tab-cooling of cells is beneficiary compared to surface-cooling, since it prevents development of a temperature gradient between the layers of the cell, and further stated that tab-cooling is best achieved by a water-based coolant or an organic refrigerant circulated through a cold plate system built into the battery pack by a pump. However, tab-cooling is considered difficult/complicated due to the need to electrically isolate the cooling system to prevent a short circuit of the pack and to ensure that no failure of the cooling system at a joint results in the release of a coolant into the battery pack itself.

Effective cold plate design often leads to a higher pressure drop across the battery pack due to the required long length and narrow coolant channels, which requires an electric coolant pump to generate both high flow rates and high static pressures. Once the coolant has passed through the battery pack, it is circulated through a heat exchanger for transferring the heat to ambient air flow or air cooled by a refrigerant chiller system. This two-phase cooling allows the battery to be kept at an optimum temperature that is below ambient. However, although this reduces the overall power consumption of the system it adds more components and cost.

Accordingly, a need exists for an efficient, cost effective and energy saving cooling system to keep electric batteries at a constant desired temperature.

### SUMMARY OF INVENTION

In a first aspect, the present invention provides a battery module/pack 100 comprising: (a) at least one battery cell 101; and (b) at least one cooling layer 102 associated with a wall of said at least one battery cell 101, wherein each cooling layer 102 comprises a porous material 103 having a pores size a positioned between two perforated sheets 104 having a pores size b, wherein pores size a is larger than pores size b.

In a second aspect, the present invention provides a cooling layer 102 for cooling an electric battery cell(s) 101 within a battery module/pack 100, said cooling layer 102 comprises a porous material 103 having a pores size a positioned between two perforated sheets 104 having a pores size b, wherein pores size a is larger than pores size b.

In a third aspect, the present invention provides methods of producing a cooling layer 102 for a battery module/pack 100 comprising one or more battery cells 101, the method comprising placing a porous material 103 having a pores size a between two preformed sheets 104 with pores size b.

### BRIEF DESCRIPTION OF DRAWINGS

FIGS. 1A-1B illustrate two possible embodiments of a battery module/pack according to some embodiments of the invention.

FIG. 2 illustrates one possible embodiment of a battery module/pack comprising multiple battery cells according to some embodiments of the invention.

FIG. 3 illustrates another possible embodiment of a battery module/pack comprising multiple battery cells according to some embodiments of the invention.

FIG. 4 illustrates one possible embodiment of a battery module/pack comprising multiple cylindered-shaped battery cells according to some embodiments of the invention.

### DETAILED DESCRIPTION OF THE INVENTION

The use of electric batteries is on the rise, and so is the demand for higher efficiency and cost-effective batteries. In addition, the fast life track raises a need for fast charging and long-lasting batteries. This is especially critical in electric vehicles.

The performance of electric battery cells used in electric vehicles is greatly improved when they are kept under adequate temperature control. This should be accompanied by an efficient thermal management system that by itself uses no or little power. One common way to cool a battery cell stack is cooling plates, which are thin metal fabrications that include one or more internal channels through which a coolant is pumped. Heat is conducted from the battery cells into the cooling plate and transported away by the coolant. Two plate-design types are known: extrude-tube and stamped-plate. In either design, the efficiency of the cooling plate is determined, among others, by the channel's geometry, route, width, length, etc. However, such cooling plates require pumps and other components, which add to the complexity and cost of the overall electric device, and which increases the cooling-system's power consumption.

The present invention is based on the finding that electric battery cells can be efficiently cooled by placing unique designed cooling layers around each battery cells and/or between two adjacent battery cells and submerging all in a coolant. This construction/design is simple and effective and can maintain the battery cells under adequate temperature control with minimum to no power consumption. In specific embodiments, there is also no need for a coolant-pump and/or heat exchanger.

Accordingly, in certain embodiments the present invention provides a cooling layer 102 for cooling an electric battery cell(s) 101 within a battery module/pack 100, said cooling layer 102 comprises a porous material 103 having a pores size a positioned between two perforated sheets 104 having a pores size b, wherein pores size a is larger than pores size b.

In further embodiments, the present invention provides a battery module/pack 100 comprising: (a) at least one battery cell 101; and (b) at least one cooling layer 102 associated with at least one wall of said at least one battery cell 101, wherein each cooling layer 102 comprises a porous material 103 having a pores size a positioned between two perforated sheets 104 having a pores size b, wherein pores size a is larger than pores size b.

The term “associated with at least one wall of said at least one battery cell” means that the cooling layer 102 is associated with one, two, three or more walls of the battery cell 101, or wrap it completely (without blocking electric contact thereof). The battery cell 101 may be wrapped completely or partially.

In certain embodiments, the porous material 103 is not positioned between two perforated sheets 104. In such embodiments, one side of the porous material 103 is (or designed to be) in contact with the battery cell 101, while a single layer of perforated sheet 104 is located/attached only to the other side of the porous material 103.

The terms “cell”, “electric cell” and “battery cell” as used herein interchangeably, refer to individual chemical units comprised of two electrodes and some chemicals. The chemicals react together to absorb electrons on one electrode and produce electrons on the other, like an electron pump. The pumping of electrons at a particular pressure is referred to as “voltage”. A single cell can produce only a predefined voltage—for instance, a Lithium cell has a nominal voltage of around 3.7V, an alkaline cell 1.5V, and a NiMH cell 1.2V. As such, the only way to produce higher voltages (without electronics) is to have multiple cells in series.

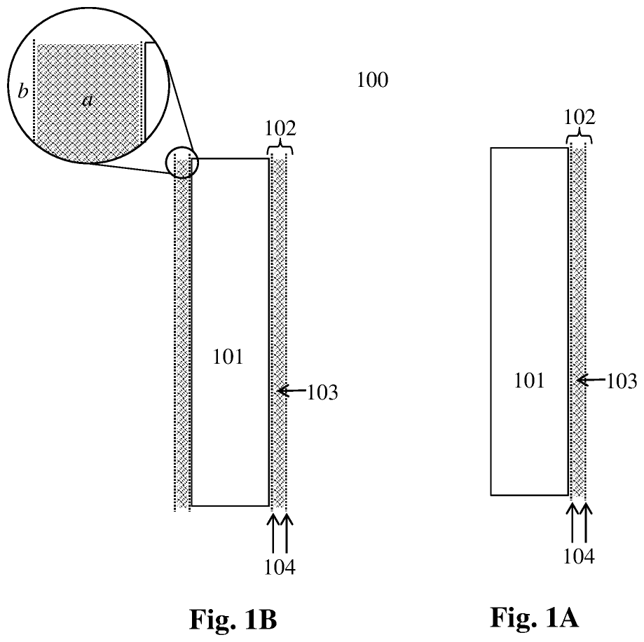

Notably, the term “battery” originates from “a number of things of a similar type”. Nevertheless, today it refers to a power source that may comprise a single electric cell. Accordingly, FIG. 1 illustrates a battery module/pack 100 comprising a single battery cell 101 having a single cooling layer 102 attached thereto (FIG. 1A) to one wall/side thereof, or comprising a single battery cell 101 between two cooling layers 102 (FIG. 1B), i.e. attached to both sides/walls thereof.

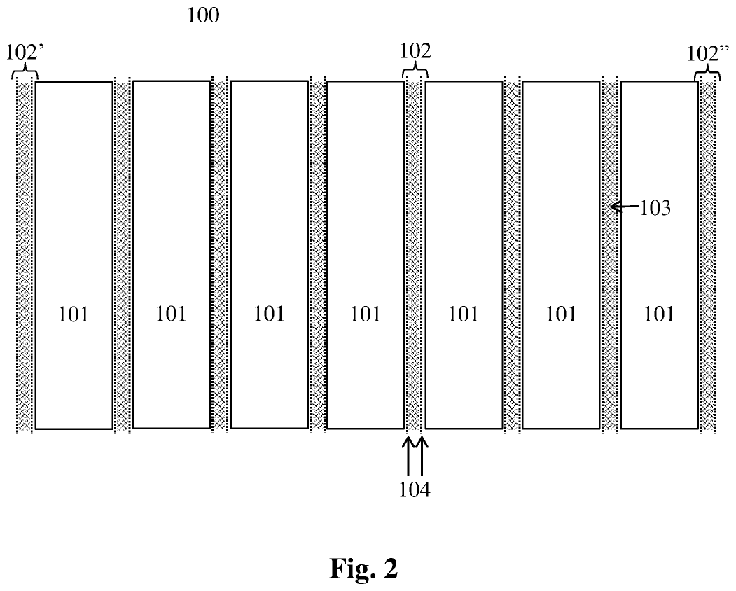

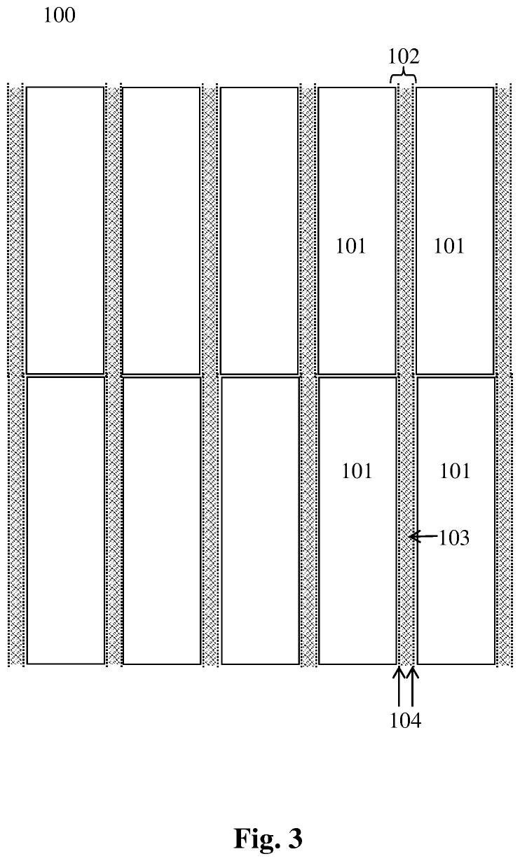

However, in most cases, i.e. when batteries with high voltage is needed, there is a need of multiple cells attached together, e.g. in a battery pack. Accordingly, FIG. 2 illustrates such a battery module/pack 100 comprising a multiple battery cells 101 arranged in a row and separated from one another by a single cooling layer 102. Also illustrated in FIG. 2 are two cooling layers 102, each one located at an opposite end of the cell row (102′ & 102″). FIG. 3 illustrates yet another battery module/pack 100 comprising a multiple battery cells 101 arranged in two rows, such that two adjacent cells are separated by a single cooling layer 102. In a specific embodiment, a cooling layer 102 may also be placed between the two rows (not shown) and/or at the sides of each row (up & down in the figure, not shown).

Accordingly, in certain embodiments, the battery module/pack 100 of the invention comprises (a) two or more adjacent battery cells 101; and (b) a cooling layer 102 interposed between said two adjacent battery cells 101. This cooling layer 102 creates a physical separation between such two adjacent battery cells 101 from one another.

In specific embodiments, a cooling layer 102 may be placed on top and/or at the bottom and/or sides of the row of electric cells.

In certain embodiments of the battery module/pack 100 of the invention, each one of said at least one battery cells 101 has two cooling layers 102, each layer associated with an opposite wall of the battery cell 101 so that two adjacent cells are not in direct contact with one another. Notably, a single cooling layer 102 may be associated with two adjacent cells 101 so that the layer is associate with one wall of one cell and with another (opposite) wall of the adjacent cell (see illustrated in FIG. 2). Alternatively, two cooling layers 102 may be used, i.e. each one associated with one of the adjacent cells 101 so that the two cooling layers are present between two adjacent cells 101 (not shown).

In certain embodiments, associating/placing a single cooling layer 102 with a battery cell wall is sufficient to maintain the battery cell 101 cool at a desired temperature range. In further embodiments, associating/placing two cooling layers 102 with a battery cell 101 (each on an opposite wall thereof) is required to maintain the battery cell 101 cool at a desired temperature range. This might be needed at hot climate and/or conditions that cause the battery to generate excessive heat.

Various electric cells are known, each having its own advantages and disadvantages, and some designed for specific usage. For instance, a cylindrical cell, which is one of the most widely used packaging styles for primary and secondary batteries. The advantages of cylindrical cells are ease of manufacture and good mechanical stability. The tubular cylinder can withstand high internal pressures without deforming. Other cell styles include button-cells; prismatic cells that resemble a box and provide efficient packaging by using the layered approach, packaged in, e.g., welded aluminum housings; and pouch cells that also present high packaging efficiency without using solid housing.

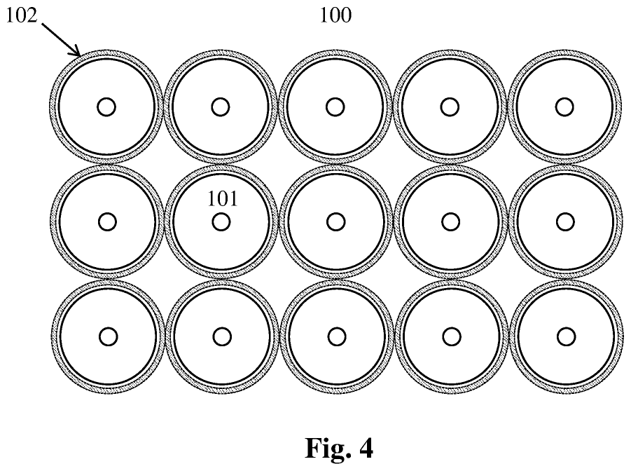

The present invention relates to all cell types, shapes and sizes. For instance, if the battery pack 100 includes tubular cylinder cells, then the cooling layer 102 may be tubular shaped so as to fit the tubular cylinder cells, such that each cell 101 is surrounded by the cooling layer 102 (see illustrated in FIG. 4 showing a top view of a cylinder cells battery).

Accordingly, in specific embodiments of the battery module/pack 100 of the invention, each of said at least one battery cell 101 is surrounded by an independent cooling layer 102 so that the cells are not in direct contact with one another.

In certain embodiments, the battery module/pack 100 of any of the embodiments above is submerged in a refrigerant/coolant.

In certain embodiments, the battery module/pack 100 of the invention constitutes a two phase cooling system, in which the battery cells 101 and cooling layers 102 associated therewith (or in between them) are submerged in a refrigerant/coolant having a boiling point that is compatible to the battery cell desired working temperature. In such a system, the heat generated by the battery cells 101 boils and evaporates the refrigerant/coolant, and its latent heat of evaporation leads to the cooling of the battery cells 101.

In specific embodiments, the vapors of the refrigerant/coolant travel or are delivered to an external condenser where they return to liquid form, which is then returned to the battery module/pack 100. Such a configuration may require the use of at least one pump—for withdrawing the vapors and/or for returning of the liquid. Alternatively, the vapors merely go/evaporate to the top of the pack (i.e. the “ceiling” of the pack) where they condense back to liquid that flows/drips back down, thereby obviating the need of a pump.

Non-limiting examples of possible refrigerant/coolant are fluorocarbons, chlorofluorocarbons, ammonia, sulfur dioxide, and non-halogenated hydrocarbons (e.g. propane).

In certain embodiments, the battery module/pack 100 of the invention further comprises a housing for holding the battery cells 101 and the cooling layer(s) 102. In specific embodiments, the housing further holds/contains a refrigerant/coolant that the battery cell(s) 101 and cooling layer(s) 102 are submerged in. In yet further specific embodiments, the battery module/pack 100 of the invention further comprises a condensation system associated therewith.

In specific embodiments of the battery module/pack 100 of the invention, which further comprises a housing, the battery cells 101 within the housing are arranged in two or more levels and/or two or more rows, wherein between two adjacent cells 101 a cooling layer 102 is positioned. In further specific embodiments, each cell 101 is surrounded by an independent/individual cooling layer 102 (see, e.g., FIG. 4).

As noted above, the cooling layer 102 may be positioned in between two adjacent cells 101; may be surrounding each individual cell 101; and/or may be partially or entirely engulfing/wrapping each cell 101. Accordingly, in certain embodiments of the battery module/pack 100 of any one of the embodiments above, the at least one cooling layer 102 is positioned underneath and/or over the battery cells 101, and/or between the battery cells 101 and optionally the housing holding them (e.g. coating the interior of the housing).

The cooling layer 102 is composed of a porous material 103 located between two perforated sheets 104. The terms “porous” and “perforated” as used herein refer to material or substrate having or fabricated so as to have many small holes to enable passage of air or liquid therethrough.

In certain embodiments, the material the porous material 103 is made of can by any suitable material that enables free passage of air and/or liquid therethrough and that is durable to heat and/or the coolant being used (if present). In addition, the structure of the porous material 103 is such that it enables free passage of air and/or liquid therethrough. Non-limiting examples of such a structure is a mesh. In specific embodiments, the mesh is made of metal, alloy, aluminum, polymer, and/or stainless steel, or any combination thereof.

In certain embodiments, the perforated sheets 104 are made of either the same of different material as the porous material 103. The perforated sheets 104 are made of any suitable material that enables free passage of air and/or liquid therethrough and that is durable to heat and/or the coolant being used (if present). In specific embodiments, the perforated sheets 104 are made of bonded fiber material, such as cellulose, polymer microfibers. In alternative specific embodiments, the perforated sheets 104 are made of woven fabric, for example, canvas.

The special correlation between the pores size of the perforated sheets 104 and that of the porous material 103, is important to obtain efficient flow of air/fluid therethrough, which is critical for the efficient cooling effect of the battery cell(s). In specific embodiments, the pores size of the porous material 103a is larger than the pores size of the two perforated sheets 104b. Such a constellation ensures that the air/fluid flows upwardly through the porous material 103 with minimum to no side-exiting via the perforated sheets 104.

Accordingly, the present invention provides a cooling layer 102 suitable for cooling an electric battery cell(s) 101, which may be positioned within a battery module/pack 100 (e.g. as defined herein above), wherein the cooling layer 102 comprises essentially entirely of a porous material 103 having a pores size a positioned between two perforated sheets 104 having a pores size b, wherein pores size a is larger than pores size b. In specific embodiments, the porous material 103 and the perforated sheets 104 are made of different materials. In alternative specific embodiments, they are made of the same material, but with different pores sizes.

In further embodiments, the present invention provides a method of producing a cooling layer 102 suitable for cooling an electric battery cell(s) 101, which may be positioned within a battery module/pack 100 that comprises one or more battery cells 101, the method comprising placing a porous material 103 having a pores size a between two preformed sheets 104 with pores size b, wherein pores size a is larger than pores size b. In specific embodiments, the porous material 103 is fabricated within the perforated sheets 104, e.g. by molding. In alternative specific embodiments, the perforated sheets 104 are affixed onto the porous material 103 once it is formed. A skilled artisan would find it obvious to utilize any suitable method for fabrication of perforated material for the fabrication of the present cooling layer 102.

In certain embodiments, the present invention further provides a cooling layer 102 produced according to any suitable method, such as a method of any of the embodiments above. In further embodiments, the present invention provides a battery module/pack 100 that includes the cooling layer 102.

The cooling layer 102 and/or the battery module/pack 100 of any of the embodiments above can be used in any electric-activated environment or device. In a specific embodiment, the electric-activated device is a vehicle. In a further specific embodiment, it is an electric car or any other vehicle. In alternative specific embodiments, the electric-activated device is an energy storage that comprises the battery module/pack 100 of any one of the embodiments above.

In certain embodiments, the battery module/pack 100 according to the invention, or any device comprising same, is designed to prevent overheating of the battery cells, during regular and excessive use, as well as during fast charging and discharging, even when exposed to a high surrounding temperature, e.g. as in the desert where temperature can reach over 45° C.

In certain embodiments, the present invention provides a method for maintaining a battery module/pack 100 at a constant desired temperature during use and charging thereof, the method comprising embedding or surrounding each one of the cells 101 within the battery module/pack 100 with a cooling layer 102, wherein the cooling layer 102 comprises essentially entirely of a porous material 103 having a pores size a positioned/located between two preformed sheets 104 with pores size b.

1. A battery module/pack 100 comprising:
a) at least one battery cell 101; and
b) at least one cooling layer 102 associated with a wall of said at least one battery cell 101,
wherein each cooling layer 102 comprises a porous material 103 having a pores size a positioned between two perforated sheets 104 having a pores size b,
wherein pores size a is larger than pores size b.

2. The battery module/pack 100 of claim 1, comprising:
a) two or more adjacent battery cells 101; and
b) a cooling layer 102 interposed between said two adjacent battery cells 101.

3. The battery module/pack 100 of claim 1, wherein each of said at least one battery cell 101 has two cooling layers 102, each layer associated with an opposite wall of the battery cell 101.

4. The battery module/pack 100 of claim 1, which is submerged in a refrigerant/coolant.

5. The battery module/pack 100 of claim 1, further comprising housing for holding the battery cells 101 and the cooling layer(s) 102.

6. The battery module/pack 100 of claim 1, wherein at least one cooling layer 102 is positioned underneath and/or over the battery cells 101, and/or between the battery cells 101 and a housing that holds them.

7. The battery module/pack 100 of claim 1, wherein the porous material 103 is a mesh.

8. The battery module/pack 100 of claim 1, wherein the perforated sheets 104 are made of bonded fiber material.

9. The battery module/pack 100 of claim 1, wherein the perforated sheets 104 are made of woven fabric.

10. A cooling layer 102 for cooling an electric battery cell(s) 101, wherein said cooling layer 102 comprises a porous material 103 characterized in having a pores size a positioned between two perforated sheets 104 having a pores size b, wherein pores size a is larger than pores size b.

11. A method of producing a cooling layer 102 for a battery module/pack 100 comprising one or more battery cells 101, the method comprising placing a porous material 103 having a pores size a between two preformed sheets with 104 pores size b.

12. A cooling layer 102 produced by the method of claim 11.

13. A battery module/pack 100 including the cooling layer 102 of claim 10.

14. A vehicle comprising a battery module/pack 100 according to claim 1.

15. An energy storage comprising a battery module/pack 100 according to claim 1.

16. A battery module/pack 100 including the cooling layer 102 of claim 12.

17. A vehicle comprising a battery module/pack 100 according to claim 13.

18. An energy storage comprising a battery module/pack 100 according to claim 13.

19. A vehicle comprising a battery module/pack 100 according to claim 16.

20. An energy storage comprising a battery module/pack 100 according to claim 16.
